(19) United States
(12) Patent Application Publication
(10) Pub. No.: US 2006/0083307 A1
(43) Pub. Date: Apr. 20, 2006

(54) Apparatus and method for calculating the reference address of motion compensation of an image

(75) Inventor: Fu-Chung Chi, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 11/062,458

(22) Filed: Feb. 22, 2005

(30) Foreign Application Priority Data
Oct. 19, 2004 (TW) 93131648

(51) Int. Cl. H04N 11/02; H04N 7/12; H04B 1/66; H04N 11/04

(52) U.S. Cl. 375/240.16

(57) ABSTRACT

An apparatus and method for calculating the reference address of motion compensation of an image is used for calculating the reference address of motion compensation of an image in MPEG4 and DivX format. The apparatus comprises a shifter for logically shifting the motion vector of an image to the right by three bits, a block offset address table for providing the offset address, a motion vector amended look-up table for providing the difference between the value by shifting logically the motion vector of an image to the right by three bits and a verification model and an adder for adding the value by shifting the motion vector of the image to the right by three bits and the block offset address of the image. The apparatus for calculating the reference address of motion compensation of an image simplifies the circuit and gets a correct result.

### BACKGROUND OF THE INVENTION

1. Field of the Invention

The present invention relates to an apparatus and method for calculating the reference address of motion compensation of an image. In particular, this invention provides an apparatus and method for calculating the reference address of motion compensation of an image in MPEG4 and DivX format.

2. Description of the Related Art

A decoder decodes every compressed micro block of MPEG4 and DivX images by referencing the previous picture that is being transmitted and decoded. In order to compress the motion picture into a macro block more efficiently, every macro block is relative to its previous macro block. The offset address between the macro blocks is called a motion vector. Therefore, how the motion vector is calculated will affect the efficiency of the decoder.

The motion vector of a chrominance block in a MPEG4 or a DivX image is calculated by referencing the motion vector of a luminance block. In the non_inter_laced_predictation direct mode of MPEG4, the motion vector is calculated by referencing the motion vector of the last image that has the same address. The Inter4V mode of DivX means that there are four motion vectors in the bit-stream of the macro block. According to the specifications, the circuit for calculating the verification model in the Inter4v mode of DivX and in the non_inter_laced_predictation direct mode of MEG4 is complex. The circuit needs to be simplified to improve the efficiency of the decoding process.

Please refer to FIG. 1, which is the circuit of the prior decoder for decoding DivX images. The circuit comprises a controller 1, a DRAM 2, a bit stream decoder 3, an invert discrete cosine decoder 4, a motion compensator 5, a motion vector decoder 6 and a frame register 7. The motion vector decoder 6 comprises a circuit for calculating the reference address of motion compensation 8.

Please refer to FIG. 2, which is the prior motion vector circuit for calculating the verification model of a DivX image. The circuit comprises an absolute value transfer circuit 11, a look-up table 12 for proving the remainder, a shifter 13 for dividing the motion vector by 16 and multiplying the motion vector by 2, an adder 14 for adding the remainder from the look-up table 12 and the result of the shifter 13. After that, the final value needs to be checked whether it is positive or negative according to the motion vector. The absolute value transfer circuit 12, decides whether the motion vector is positive or negative. If the motion vector is positive, the final value doesn't need to change. If the motion vector is negative, the final value needs to do a 2's complement transform operation. Therefore, the motion vector circuit for calculating the verification model of DivX also comprises a 2's complement transform circuit 15. The formula is A=˜A+1, A means a value. The 2's complement transform circuit 15 comprises an adder. There are three adders and some additional circuits for calculating the motion vector of the chrominance block for the verification model of DivX images. The circuit is very complex.

For calculating the verification model of MPEG4 images, the circuit comprises two invertors and three adders. The circuit is also very complex. FIG. 3 shows the prior circuit for calculating the reference address of the motion compensator. The circuit comprises a circuit for calculating the motion vector 21, a block offsets an address table 22 and an adder 23. Therefore, the circuit for calculating the motion vector of MPEG4 and DivX images is complex and includes a lot of transistors.

### SUMMARY OF THE INVENTION

The main purpose of the present invention is to provide an apparatus and method for calculating the reference address of motion compensation for an image in MPEG4 and DivX format. In the present invention, the circuit will be simplified.

In order to achieve the above goal, the present invention provides an apparatus for calculating the reference address of motion compensation of an image. The apparatus comprises a shifter for logically shifting the motion vector of the image to right three bits, a block offset address table for providing the offset address of a calculated-image, a motion vector amended look-up table for providing the difference between the value by shifting logically the motion vector of the image to the right by three bits and a verification model, and an adder for adding the value by shifting the motion vector of the image to the right by three bits and the offset address of an image block. The apparatus for calculating the reference address of motion compensation of an image can simplify the circuit and get a correct result.

For further understanding of the invention, reference is made to the following detailed description illustrating the embodiments and examples of the invention. The description is only for illustrating the invention and is not intended to be considered limiting the scope of the claim.

### BRIEF DESCRIPTION OF THE DRAWINGS

The drawings included herein provide a further understanding of the invention. A brief introduction of the drawings is as follows:

FIG. 1 is a circuit diagram of the image decoder of a DivX image of the prior art;

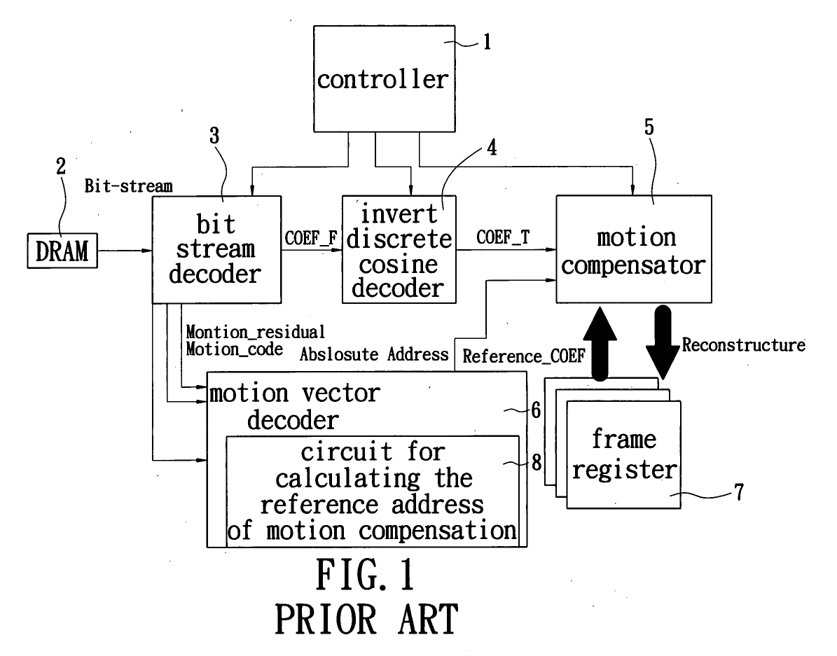

FIG. 2 is a circuit diagram for calculating the motion vector of a DivX image of the prior art;

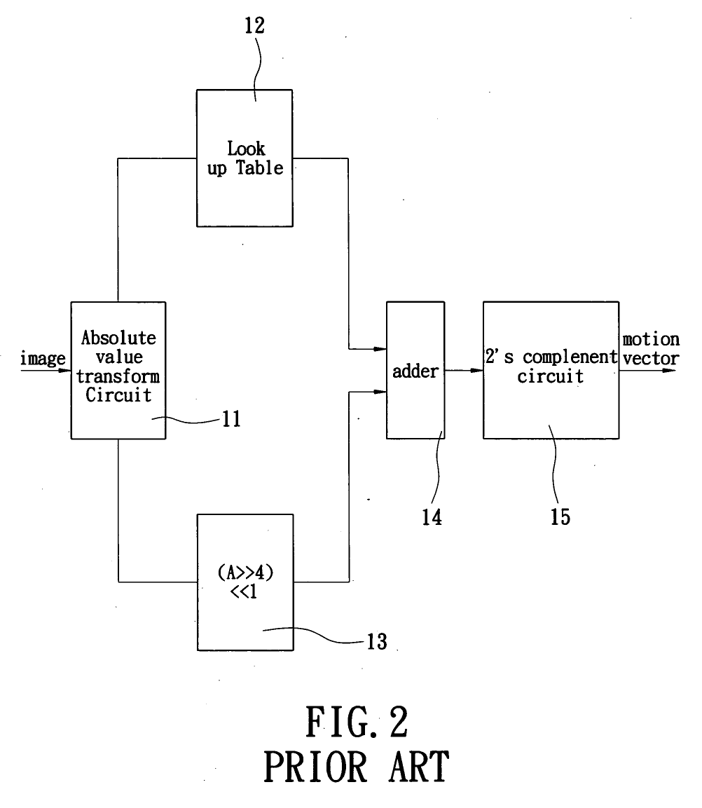

FIG. 3 is a circuit diagram for calculating the reference address of motion compensation of a DivX image of the prior art;

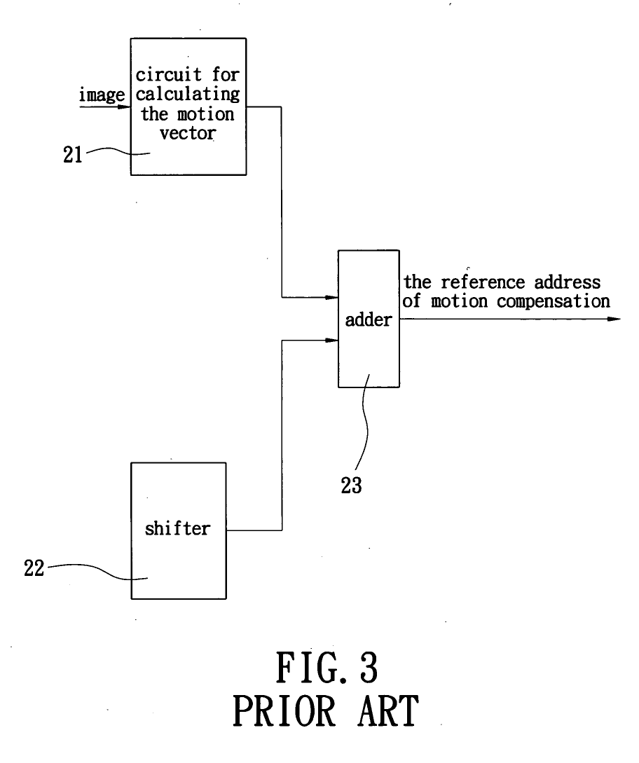

FIG. 4 is a circuit diagram for calculating the reference address of motion compensation of the present invention;

FIG. 5 is a comparison diagram of the difference between the value by shifting logically the motion vector of an image to the right by three bits and a verification model;

FIG. 6 is a circuit diagram for calculating the motion vector of the present invention; and

FIG. 7 is a flow chart for calculating the reference address of motion compensation of the present invention.

### DETAILED DESCRIPTION OF THE PREFERRED EMBODIMENTS

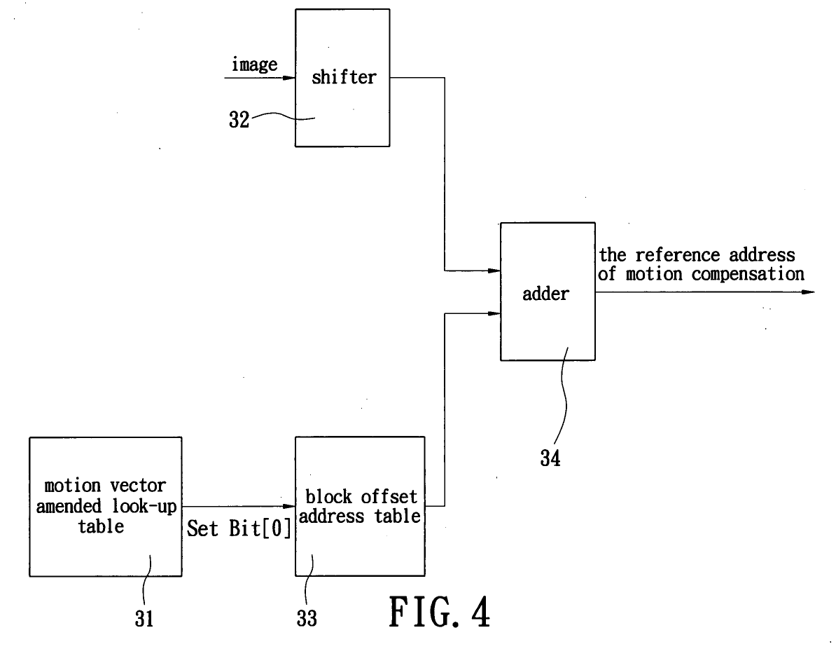

Referring to FIG. 4, the present invention provides an apparatus for calculating the reference address of motion compensation of an image. The apparatus for calculating the reference address of motion compensation of an image comprises a shifter 32, the shifter 32 comprises three bit-shifters for shifting logically the motion vector of the image to the right by three bits, a motion vector amended look-up table 31 for providing the difference between the value by shifting logically the motion vector of the image to the right by three bits and a verification model. The value in the motion vector amended look-up table 31 is pre-calculated. The motion vector amended look-up table 31 uses the bit 0 to bit 3 of motion vector as a unit, every sixteen values composes a repeat cycle. The third, forth, fifth, sixth, seventh, fourteenth and fifteenth value of the verification model are different from the value by shifting logically the motion vector of the image to the right by three bits. The difference is 1. The others are the same. Whether the motion vector is positive or negative, the symptom is same.

The apparatus for calculating the reference address of motion compensation of an image also comprises a block offset address table 33. The block offset address table 33 connects to the motion vector amended look-up table 31, for providing the offset address of a calculated motion vector. The offset address is an offset address of a calculated motion vector relating to the origin of the picture. The bit 0 of the block offset address table 33 can be set by the amended value of the motion vector amended look-up table 31, because the offset address of a block is a multiple of eight the bit 0, bit 1 and bit 2 of the offset address of block are zero. Finally, the apparatus comprises an adder 34. The adder 34 is connected to the shifter 32 and the block offset address table 33 for adding the value by shifting logically the motion vector of an image to the right by three bits and the offset address of an image block. This apparatus can get the reference address of motion compensation of an image.

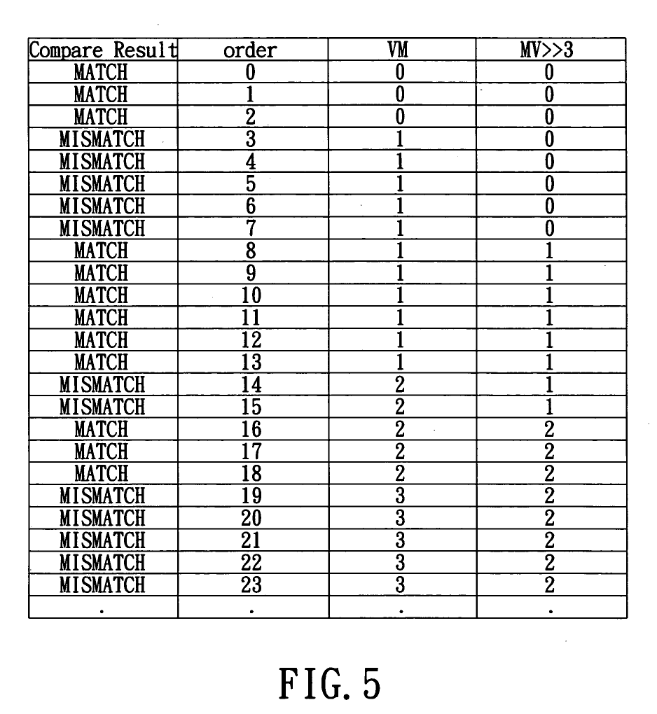

FIG. 5 is a comparison diagram of the difference between the value by shifting logically the motion vector of an image to the right by three bits and the verification model. The data comes from calculating the verification model and shifting logically the motion vector of an image to the right by three bits by C-language programming. The first column of the diagram is the comparison result. The second column of the diagram is the order. The third column of the diagram is the value of the verification model. The fourth column of the diagram is the value by shifting logically the motion vector of an image to right three bits. The conclusion from the diagram is the third, forth, fifth, sixth, seventh, fourteenth and fifteenth value of the verification model are different from the value by shifting logically the motion vector of the image to the right by three bits. The difference is 1 and the others are same. Using the bit 0 to bit 3 of motion vector as unit, every sixteen values compose a repeat cycle. Whether the motion vector is positive or negative, the symptom is same.

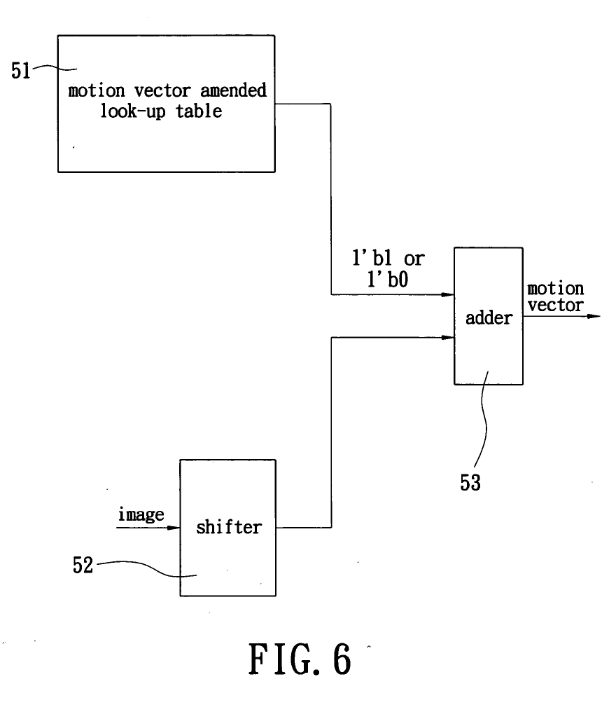

FIG. 6 is a circuit diagram for calculating the motion vector of the present invention. The apparatus for calculating the motion vector of an image comprises a shifter 52, the shifter 52 comprises three bit-shifters for shifting logically the motion vector of an image to the right by three bits, a motion vector amended look-up table 51 for providing the difference between the value by shifting logically the motion vector of the image to the right by three bits and the verification model. The value in the motion vector amended look-up table 51 is pre-calculated. The motion vector amended look-up table 51 uses the bit 0 to bit 3 of the motion vector as a unit; every sixteen values compose a repeat cycle. The third, forth, fifth, sixth, seventh, fourteenth and fifteenth value of the verification model are different from the value by shifting logically the motion vector of the image to the right by three bits. The difference is 1. The others are same. Whether the motion vector is positive or negative, the symptom is the same. Finally, the apparatus comprises an adder 53. The adder 53 is connected to the shifter 52 and the motion vector amended look-up table 51 for adding the value by shifting logically the motion vector of an image to the right by three bits and the amended value of the motion vector amended look-up table 51. This apparatus gets the motion vector of an image.

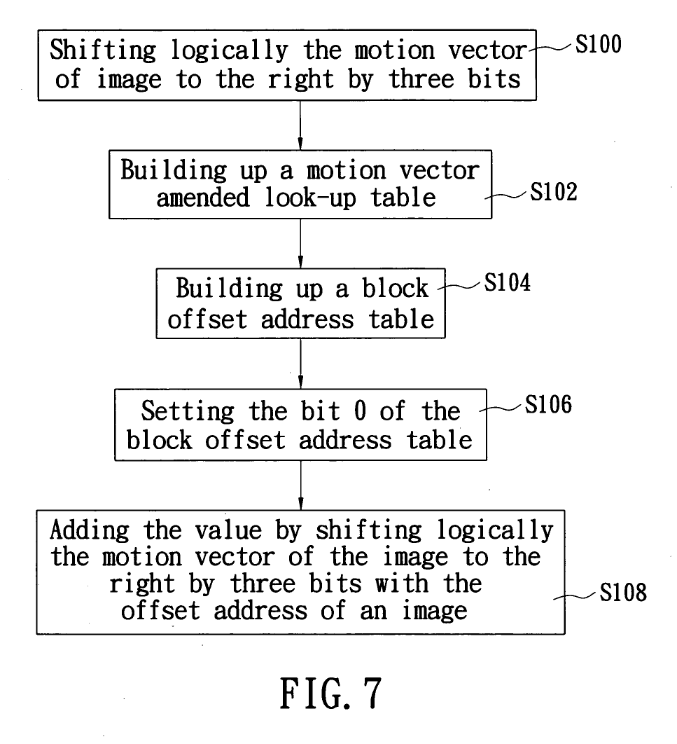

FIG. 7 is a flow chart for calculating the reference address of motion compensation of the present invention. The steps are as following: shifting logically the motion vector of image to the right by three bits at S100. Then, building up a motion vector amended look-up table at S102. The motion vector amended look-up table comes from calculating the difference between the value by shifting logically the motion vector of the image to the right by three bits and verification model. The motion vector amended look-up table uses the bit 0 to bit 3 of motion vector as a unit, every sixteen values compose a repeat cycle. The third, forth, fifth, sixth, seventh, fourteenth and fifteenth value of verification model are different from the value by shifting logically the motion vector of the image to the right by three bits. The difference is 1. The others are the same. Whether the motion vector is positive or negative, the symptom is the same. Next, building up a block offset address table at S104. The block offset address is predetermined. The block offset address means an offset address from the calculated block of an image to an origin point of an image. Setting the bit 0 of the block offset address table at S106. The value of bit 0 of block offset address table is determined by the value of the motion vector amended look-up table. The bit 0 of the block offset address table is set to 1 when the order of the motion vector is the third, forth, fifth, sixth, seventh, fourteenth or fifteenth order. The bit 0 of the block offset address table can be set by the amended value of the motion vector amended look-up table, because the offset address of the block is a multiple of eight, the bit 0, bit 1 and bit 2 of the offset address of block are all zero. Adding the value by shifting logically the motion vector of the image to the right by three bits with the offset address of an image to get the reference address of motion compensation of an image at S108.

Building up a motion vector amended look-up table at S102 further comprises: calculating the verification model of a DivX image by C-language programming according to the spec of the Inter4V mode of DivX. The program gets the absolute value of a motion vector by dividing by 16, multiplying by 2 and adding the remainder of the absolute able of motion vector. It then decides the sign of the value according to the motion vector. Secondly, calculating the value of shifting logically the motion vector of the image to the right by three bits by C-language programming. FIG. 4 shows the comparison result of the two above values. Naturally, the calculation tool is not specified. The result is that the motion vector amended look-up table uses the bit 0 to bit 3 of motion vector as a unit, every sixteen values compose a repeat cycle. The third, forth, fifth, sixth, seventh, fourteenth and fifteenth value of the verification model are different from the value by shifting logically the motion vector of the image to the right by three bits. The difference is 1. The others are the same. Whether the value of the motion vector is positive or negative, the symptom is same.

The calculating result according to the spec of non_inter_laced_predictation direct mode of MEG4 for calculating the motion vector of a chrominance block is same as for DivX. The present invention applies to these two specs.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An apparatus for calculating the reference address of motion compensation of an image, comprising:
a shifter, logically shifting the motion vector of an image to the right by three bits;
a motion vector amended look-up table, providing the difference between the value by shifting logically the motion vector of the image to the right by three bits and a verification model;
a block offset address table, connected to the motion vector amended look-up table, providing the offset address of a calculated picture related to an original point of the image; and
an adder, connected to the shifter and the block offset address table, for adding the value by shifting logically the motion vector of the image to the right by three bits and an offset address to get the reference address of motion compensation of an image.

2. The apparatus for calculating the reference address of motion compensation of an image of claim 1, wherein the shifter comprises three bit shifters.

3. The apparatus for calculating the reference address of motion compensation of an image of claim 1, wherein the bit 0 of the block offset address table is set according to the value of the motion vector amended look-up table.

4. The apparatus for calculating the reference address of motion compensation of an image of claim 1, wherein the motion vector amended look-up table uses the bit 0 to bit 3 of motion vector as a unit, every sixteen values compose a repeat cycle. The third, forth, fifth, sixth, seventh, fourteenth and fifteenth value of the verification model are different from the value by shifting logically the motion vector of the image to the right by three bits. The difference is 1. The others are the same.

5. An apparatus for calculating the reference address of motion compensation of an image, comprising:
a shifter, logically shifting the motion vector of an image to the right by three bits;
a motion vector amended look-up table, providing the difference between the value by shifting logically the motion vector of the image to the right by three bits and the verification model; and
an adder, connected to the shifter and the motion vector amended look-up table, for adding the value by shifting logically the motion vector of the image to the right by three bits and the value of the motion vector amended look-up table to get the motion vector of an image.

6. The apparatus for calculating the reference address of motion compensation of an image of claim 5, wherein the shifter comprises three bit shifters.

7. The apparatus for calculating the reference address of motion compensation of an image of claim 5, wherein the motion vector amended look-up table uses the bit 0 to bit 3 of motion vector as a unit, every sixteen values compose a repeat cycle. The third, forth, fifth, sixth, seventh, fourteenth and fifteenth value of the verification model are different from the value by shifting logically the motion vector of the image to the right by three bits. The difference is 1. The others are the same.

8. A method for calculating the reference address of motion compensation of an image, comprising:
shifting logically the motion vector of the image to the right by three bits;
building up a motion vector amended look-up table, the motion vector amended look-up table comes from calculating the difference between the value by shifting logically the motion vector of the image to the right by three bits and the verification model;
building up a block offset address table, the block offset address is predetermined, the block offset address means an offset address from the calculated block of the image to an original point of image;
setting the bit 0 of the block offset address table, the value of bit 0 of the block offset address table is determined by the value of the motion vector amended look-up table; and
adding the value by shifting logically the motion vector of the image to the right by three bits with the offset address of an image to get the reference address of motion compensation of the image.

9. The method for calculating the reference address of motion compensation of an image of claim 8, wherein the step of building up a motion vector amended look-up table further comprises:
calculating the value of the verification model of the image, to calculate the value of the verification model of the image according to the spec of the imagine;
calculating the value of shifting logically the motion vector of the image to the right by three bits; and
comparing the above values, the result is that the motion vector amended look-up table uses the bit 0 to bit 3 of motion vector as a unit, every sixteen values composes a repeat cycle. The third, forth, fifth, sixth, seventh, fourteenth and fifteenth value of the verification model are different from the value by shifting logically the motion vector of the image to the right by three bits. The difference is 1. The others are the same.
